(19) United States
(12) Patent Application Publication
(10) Pub. No.: US 2012/0160531 A1
(43) Pub. Date: Jun. 28, 2012

(54) ADD-ON HANDLE, HANDHELD POWER TOOL, SYSTEM

(75) Inventors: Paul MARTIN, Karlsruhe (DE); Stefan HAMMERSTINGL, Muenchen (DE)

(73) Assignee: Hilti Aktiengesellschaft, Schaan (LI)

(21) Appl. No.: 13/332,617

(22) Filed: Dec. 21, 2011

(30) Foreign Application Priority Data
Dec. 22, 2010 (DE) 10 2010 063 912.5

(51) Int. Cl. B25F 5/02; B25G 1/10; B25G 3/16; B25D 17/04

(52) U.S. Cl. 173/46; 81/489

(57) ABSTRACT

An add-on handle connectable to a handheld power tool, including
a fastener attachable to a connection area,
a hoop-shaped grip for handling purposes, and
a locking coupler connecting the grip and the fastener.

By rotating the grip, the locking coupler can be moved between an attachment position and a detachment position, the locking coupler

having a first coupling part actuatable via the grip and a second coupling part configured to change the position of the fastening element. The first and second coupling parts engage axially with each other, forming a bayonet catch of the locking coupler between the coupling parts. The bayonet catch has an engagement element movable so as to engage with a guide so that, when the engagement element is moved between a first point of the guide and a second point of the guide, the fastener is moved between the attaching position and the detaching position.

This claims the benefit of German Patent Application DE 10 2010 063 912.5, filed Dec. 22, 2010 and hereby incorporated by reference herein.

The invention relates to an add-on handle. The invention also relates to a handheld power tool, for example, in the form of an electric power tool or the like. Furthermore, the invention relates to a system including a handheld power tool and an add-on handle that can be arranged, for example, as a system in a toolbox or the like.

Many handheld power tools have at least one connection option for an add-on handle of the above-mentioned type. An add-on handle is meant to facilitate the handling of the power tool and/or to absorb torques that might occur. Consequently, an add-on handle is a relevant component from the standpoint of product approval.

### BACKGROUND

The assignee of the present application has disclosed an add-on handle, for example, in German patent application DE 37 310 59 A1 and in European patent application EP 21 219 41 A1. Here, the add-on handle is fastened by means of a screwed connection between a fastening element and the grip of the add-on handle. In the above-mentioned applications, the fastening element is configured as a strap or a clamp and it grasps the neck of the handheld power tool with a non-positive fit when the screwed connection is tightened.

### BRIEF SUMMARY OF THE INVENTION

The invention relates to an add-on handle in which the grip that is provided for handling purposes is configured like a hoop. The term “like a hoop” within the scope of this application refers especially to a grip whose handling area is approximately U-shaped, that is to say, it has a shape having a crosspiece and two legs. The preferred gripping area of the handling area in such a hoop-shaped grip constitutes the crosspiece. Such an add-on handle lends itself particularly well as a side handle.

In order to reduce fatigue during the work, a change in the position of the add-on handle on the handheld power tool makes it possible to shift the center of gravity of the entire device relative to the user. For this purpose, it is always possible to change the position of the add-on handle relative to handheld power tool in the working direction as well as rotationally around the axis of the working direction, in any case, once the fastening element has been loosened. Moreover, different positions of the add-on handle might be necessary or ergonomically beneficial for different applications of the handheld power tool. It might be necessary for users to change the position of the add-on handle quite often right away and usually in a hurry while they are performing the work. Therefore, changing the position of the add-on handle should be as quick and efficient as possible. Fundamentally speaking, there are different ways to change the position of a hoop-shaped grip in accordance with the above-mentioned principle.

In particular, German patent application DE 10 2008 042111 A1 of the present assignee discloses an add-on handle for a handheld power tool such as a power drill, a hammer drill, a chisel hammer or the like, whose position can be changed by tilting the handle around an axis that is oriented perpendicular to the working direction and tangentially to the neck of the device. For this purpose, the add-on handle has a blockable swivel joint with an axial bearing bolt at whose end there is a tightening element for tightening and loosening a clamping section of a fastening element. The add-on handle has a blocking mechanism for blocking or releasing the swivel element. Moreover, an unlatching mechanism that is independent of the tightening element is provided, whose actuation allows the blocking mechanism to be changed from a blocking position into a releasing position. However, this concept, which meets relatively high safety standards, also calls for a relatively laborious procedure in order to change the position of the add-on handle. Depending on the work situation, the blocking mechanism and/or the unlatching mechanism have to be actuated by the user before the position of the add-on handle on the handheld power tool can be changed.

It is desirable to provide users with a relatively simple and yet safe modality for handling the add-on handle.

It is an object of the present invention to provide an add-on handle, a handheld power tool and a system that, in comparison to the state of the art, are intended to provide improved handling of the add-on handle by means of the hoop-shaped grip on the handheld power tool. In particular, the attachment of the add-on handle should be configured so as to be relatively simple and yet safe.

The present invention is based on the consideration that the handling of the add-on handle can be configured in a simpler manner while dispensing with an additional operating element. Nevertheless, this should not come at the expense of safe handling. Towards this end, it has been recognized with the invention that it is advantageously possible to attach and detach the add-on handle by means of a rotating movement of the grip itself. According to the invention, it is provided that a locking coupler that connects the grip and the fastening element can be moved between a first position and a second position by rotating the grip around an axis of the locking coupler.

In particular, a first coupling part of the locking coupler can be actuated via the grip. In particular, a second coupling part of the locking coupler is configured to change the position of the fastening element. The first position is especially the position that attaches the fastening element. The second position is especially the position that detaches the fastening element. The first and/or second positions can also be different positions that have proven to be advantageous for the user when it comes to handling the handheld power tool in a concrete work situation.

The locking coupler can be opened and closed by making a rotational movement. For this purpose, the invention puts forward a bayonet catch situated between coupling parts of the locking coupler. With the invention, it has been recognized that, in a particularly advantageous manner, a bayonet catch can be opened and closed by rotating the grip itself. In particular, the invention has recognized that a bayonet catch advantageously offers the possibility to securing each of the positions, for instance, by selecting an appropriate path for the guide (by means of a slotted link) on the bayonet catch. According to the invention, a bayonet catch is provided with which an engagement element that can be moved so as to engage with a guide is configured in such a way that, when the engagement element is moved between a first point of the guide and a second point of the guide, the fastening element is moved between the attaching position and the detaching position, but in any case between a first and a second position.

Advantageously, the movement of the grip can continuously change the position of the bayonet catch between two points that are associated with an attaching and a detaching position of the fastening element. A continuous change in the position of the bayonet catch between these two points can also be selected as desired. The concept of the invention also encompasses those bayonet catches that have, for example, a stepped guide; such a bayonet catch with a stepped guide can predefine, for example, a number of catching points on the guide that can each be associated with a suitable position of the fastening element. Altogether, the concept of the invention allows a user to open or close the locking coupler by rotating the hoop-shaped grip but, in any case to change between two positions. Advantageously, a securing, blocking or unlatching function of the locking coupler can be prescribed for catching points, end points or similarly predefined points of a guide of the bayonet catch. The guide can be appropriately configured for this purpose. By means of such or similar measures, it is advantageously possible to dispense with the additional operating element that has to be provided in the case of the state of the art. Furthermore, this can simplify the handling effort required of the user for detaching or attaching the add-on handle to the handheld power tool during work.

The expression “rotation of the grip” as set forth here can also refer to just a slight rotation of the grip. For example, in a borderline case, the bayonet catch can have a guide that allows the user to push or pull the grip in the direction of the axis of the locking coupler in order to actuate the locking coupler, in other words, for the most part, to move the grip without rotating it. Towards this end, a guide of the bayonet catch can have an essentially axial path along the axis of the locking coupler. A rotational movement can be provided either at the beginning or at the end of the push or pull movement, for example, in order to latch or unlatch the locking coupler. A hoop-shaped path with a receding area can be provided for this purpose. Generally speaking, however, it is also advantageous to provide the guide of a bayonet catch with an essentially slanted or triangular path. The guide can be devoid of corners, can be round or similarly optimized in order to allow users to execute a smooth motion when handling the grip.

Within the scope of an especially preferred refinement, the axis of the locking coupler is oriented radially with respect to a connection area, especially the neck of the handheld power tool. In addition or as an alternative, the axis of the locking coupler is oriented essentially in the same direction as a leg of the hoop-shaped grip. To put it in other words, within the scope of this refinement, the concept of the invention lends itself particularly well for rotating the plane of the hoop-shaped grip around the axis of the locking coupler, a process in which the rotational axis is radial or perpendicular to a working axis of the handheld power tool.

According to the invention, the bayonet catch, which is situated between the first and second coupling parts, can have an engagement element that can be moved so as to engage with a guide. In particular, the guide can be arranged on the first coupling part, whereby the engagement element is then arranged on the second coupling part. As an alternative, the guide can be arranged on the second coupling part, whereby the engagement element is then arranged on the first coupling part. The engagement element can be configured, for example, in the form of a pin, a bar, a journal, a nub or a similar elevation. The guide can especially be configured in the form of a guiding slot, a guiding groove or a guiding flank or the like. The term “bayonet catch” as defined herein thus refers to any type of closeable slotted link guide in which the above-mentioned elevation engages with the guide or with a guide flank in order to allow a force-guided movement of the elevation and of the guide relative to each other.

With the invention, it has also been advantageously recognized that a bayonet catch allows users to effectively, reliably and clearly attach or detach the fastening element to the connection area of the handheld power tool by rotating the grip around the axis of the locking coupler. The bayonet catch can be completely opened or completely closed by a user, for instance, by rotating the grip, for example, only over a fraction of a full revolution, e.g. by half a revolution. Accordingly, the fastening element can be completely attached to or detached from the connection area of the handheld power tool by means of a complete revolution of the grip. In particular, owing to the force-guided movement of the first and second coupling parts relative to each other, the user receives recognizable feedback in the form of the resistance of the force-guided movement; in other words, especially about whether the bayonet catch is completely open or completely closed.

Within the scope of an especially preferred structural refinement, the first coupling part is fastened directly to the hoop-shaped grip and/or the second coupling part is fastened directly to the fastening element. This advantageously allows a direct transmission of force from a coupling part to a hoop-shaped grip or to a fastening element. Force transmission between the coupling part and the hoop-shaped grip or the fastening element has proven to be especially advantageous when the coupling part is shaped on or integrated in one piece. In particular, the first coupling part can be shaped in one piece together with the hoop-shaped grip and/or the second coupling part can be shaped in one piece together with the fastening element. In another refinement, connecting or force-transmitting parts can also be provided between the coupling part and the hoop-shaped grip so as to be fixed or movable.

In a first refined variant, the first coupling part can be configured in the form of a shaft, and the second coupling part in the form of a sleeve, whereby the shaft engages with the sleeve axially along the axis of the locking coupler. In a second, here especially preferred refined variant, it can be—conversely—provided that the second coupling part is configured in the form of a shaft, and the first coupling part is configured in the form of a sleeve, whereby, again, the shaft engages with the sleeve axially along the axis of the locking coupler. In particular, in the two above-mentioned variants, the first and second coupling parts can be axially guided so as to advantageously fit precisely. This is beneficial for the axial stability of the add-on handle and supports the force-guided movement of the first and second coupling part in the bayonet catch. In particular, this advantageously prevents tilting of the first and second coupling parts.

Within the scope of an especially preferred refinement, particularly the second variant mentioned, the second coupling part—in other words, the second coupling part associated with the fastening element—is configured in the form of a disk, over which the first coupling part is pulled as a counterpart of the disk in the form of a sleeve. The disk can be configured so as to be relatively flat. The counterpart of the disk can be configured so as to be pot-shaped, in other words, in the form of a sleeve that is closed at least on one end.

For example, in a refinement described within the scope of the preferred embodiment, the disk can have an engagement element that engages with a guide of the counterpart of the disk. Consequently, when the hoop-shaped grip is rotated around the axis of the locking coupler, the disk can be pulled into the counterpart of the disk and the bayonet catch can be closed.

It is advantageously provided that a spring means, preferably pre-tensioned, is arranged between the first coupling part and the second coupling part. This keeps the locking coupler under tension, so that it is ensured that the coupling parts are guided with a precise fit. For instance, the bayonet catch can be closed against the spring force and opened with the assistance of the spring force. In particular, the spring means can affix the bayonet catch in practically any desired position. This can be utilized to secure a position of the locking coupler against being accidentally detached. Preferably, the spring means is configured in the form of an elastomeric part that is inserted between the first and second coupling parts.

Within the scope of an especially preferred refinement, it is provided that the locking coupler has a tensioning means that passes through the second coupling part. The tensioning means is advantageously configured such that, when the engagement element is moved between a first point of the guide and a second point of the guide, the fastening element is moved between the attaching position and the detaching position. Advantageously, the tensioning means that passes through acts directly or indirectly upon the connection area of the handheld power tool.

Especially preferably, the tensioning means and the spring means are configured as a coupling element, preferably in the form of an elastomeric part. The tensioning means and the spring means are advantageously formed as one-piece coupling element that performs a tensioning function as well as a spring function. For example, in order to configure a spring function and a tensioning function, the coupling element can have an essentially T-shaped cross section, whereby the part of the coupling element associated with the T-upright of the cross section acts as the tensioning element, while the part of the coupling element associated with the T-crossbar of the cross section acts as the spring element. A preferred embodiment of this refinement is described on the basis of the drawing.

Generally speaking, the locking coupler advantageously has a coupling element that pre-tensions the first and second coupling parts with respect to each other. In particular, it can be provided that, when the bayonet catch is closed, the coupling element in any case partially passes through the coupling part associated with the fastening element and acts upon the connection area of the handheld power tool. In this manner, the fastening element can be pushed away from the handheld power tool together with the associated coupling part, thus affixing the fastening element to the handheld power tool, for instance, with a non-positive fit.

Irrespective of that, the fixation of the fastening element to the connection area of the handheld power tool is fundamentally possible either with a positive fir or with a non-positive fit. In this vein, the fastening element can be a tensioning element in the form of a strap or a clamp or a similar connection. The fastening element can also be a latching element such as a strap or the like.

In order to secure the locking coupler, at least in the attaching position of the fastening element, it is provided within the scope of a preferred refinement that the guide of the bayonet catch has a receding area that is associated with the attaching position of the fastening element. The expression “receding area” especially refers to an area of the guide whose pitch has the opposite algebraic sign from an area associated with the detaching position of the fastening element. In other words, the guide is provided with an extreme reversal point between two areas of this kind. As the engagement element is guided past the extreme reversal point, the bayonet catch can thus be latched in the attaching position of the fastening element. Consequently, by refining the concept of the invention, a simple rotation of the grip makes it possible to detach and close the locking coupler and to secure or lock the locking coupler at least in one position, preferably in the closed position. Accordingly, the attaching or detaching position of the fastening element on the connection area of the handheld power tool can be secured against being accidentally changed.

The concept of the invention also achieves the objective with respect to a handheld power tool of the above-mentioned type, for example, in the form of a combination device such as a hammer drill, a drill chisel or the like, especially in the form of a chisel hammer. The handheld power tool has a main handle and an add-on handle of the above-mentioned type that is connected in the connection area of the handheld power tool. For this purpose, it is provided according to the invention that the connection area is the neck of the device, whereby the add-on handle is configured as a side handle that is oriented perpendicular to the main handle.

The invention also comprises a system consisting of a handheld power tool and an add-on handle that can be placed, for example, in a tool box.

### BRIEF DESCRIPTION OF THE DRAWING

Embodiments of the invention will now be described on the basis of the drawing. The drawing does not necessarily depict the embodiments true-to-scale, but rather, the drawing is presented in schematic and/or slightly distorted form whenever necessary for the sake of clarity. Regarding additions to the teaching that can be gleaned directly from the drawing, reference is hereby made to the pertinent state of the art. In this context, it should be taken into account that a wide array of modifications and changes pertaining to the shape and the detail of an embodiment can be made, without deviating from the general idea of the invention. The features of the invention disclosed in the description, in the drawing as well as in the claims, either on their own or in any desired combination, can be essential for the refinement of the invention. Moreover, all combinations of at least two of the features disclosed in the description, in the drawing and/or in the claims fall within the scope of the invention. The general idea of the invention is not limited to the exact shape or details of the preferred embodiment shown and described below, nor is it limited to an object that would be restricted in comparison to the subject matter claimed in the claims. Regarding the dimensional ranges given, values that fall within the cited limits can also be disclosed as limit values and can be employed and claimed as desired. For the sake of simplicity, the same reference numerals will be used below for identical or similar parts or for parts having an identical or similar function.

Additional advantages, features and details of the invention ensue from the description below of preferred embodiments as well as from the drawing. This shows the following:

FIG. 1: a schematic depiction of an electrically operated handheld power tool according to a preferred embodiment, here in the form of a chisel hammer, with an add-on handle configured as a side handle, in addition to a main handle, whereby the add-on handle has a hoop-shaped grip, and a locking coupler that can be opened and closed with a bayonet catch when the hoop-shaped grip is rotated; the add-on handle is shown in two positions;

FIG. 2: an exploded view of the optional handle of FIG. 1 in detail and showing the grip, the fastening element as well as two coupling parts as well as a coupling element that simultaneously has a spring and tensioning function.

### DETAILED DESCRIPTION

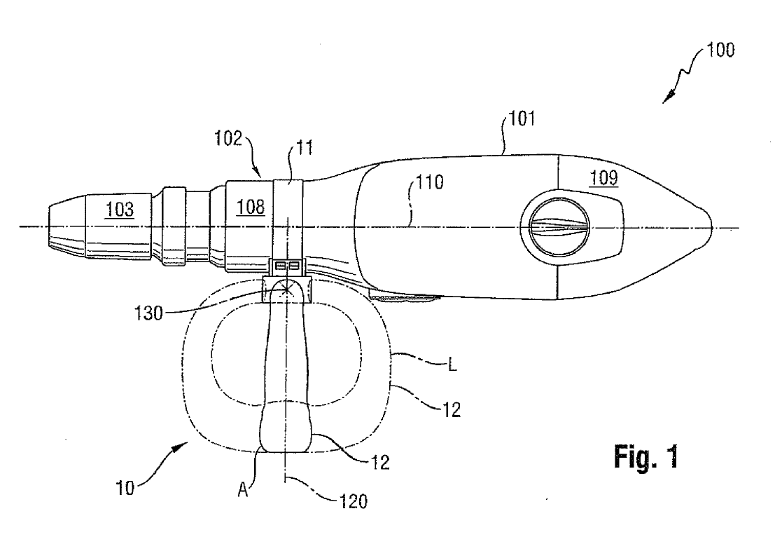

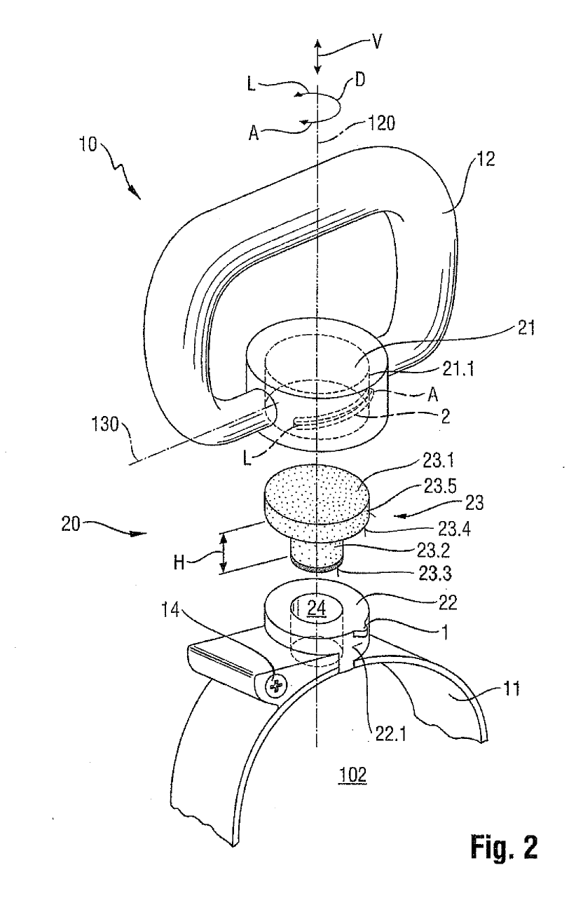

FIG. 1 shows an electrically operated handheld power tool 100, here in the form of a chisel hammer. Said chisel hammer has a housing 101 whose top is shown in FIG. 1 in a top plan view. The chisel hammer can be held on a main handle that is formed by the housing 101 and that extends underneath the rear area 109 of the housing 101. The housing 101 extends in the direction of a working axis 110 to a front area 108 that forms the neck of the device and that is directly adjacent to a tool socket 103. In the front area 108, there is a connection area 102 to which an add-on handle 10 configured as a side handle is fastened. Towards this end, the side handle is affixed to the neck of the device and it extends laterally away from the housing 101 in a direction of perpendicular to the main handle that runs underneath the rear area 109—downwards in the perspective view in FIG. 1. For the attachment to the neck of the device, the add-on handle 10 has a fastener or fastening element 11 that is configured here in the form of an adjustable strap and that will be explained in greater detail with reference to FIG. 2.

A hoop-shaped grip 12 that is configured for handling the add-on handle 10 is connected to the strap, and the grip 12 is shown in FIG. 1 in two positions A and L, rotated by 90° relative to each other.

In order to allow the rotation of the grip 12 shown in FIG. 1, the grip 12 is connected to the fastening element 11 via a locking coupler 20 that, as a part of the add-on handle 10 with the hoop-shaped grip 12 and the fastening element 11, is shown in greater detail in an exploded view in FIG. 2. A rotation D is brought about by the user who rotates the grip 12 around an axis 120 of the locking coupler shown both in FIG. 1 and in FIG. 2. The axis 120 of the locking coupler also marks an axis shared by the planes of the handle-like grip 12 in the individual rotational positions. The possible directions for the rotation D into the positions A and L are symbolically depicted on the axis 120 of the locking coupler in FIG. 2. Due to the force-guided movement brought about by the bayonet catch, the grip 12 also executes a shift V along the axis 120 of the locking coupler.

As can be seen in detail in FIG. 2, the locking coupler 20 has a first coupling part 21 that is directly connected to the hoop-shaped grip 12 and that therefore can be actuated by said grip. The locking coupler 20 also has a second coupling part 22 configured to change the position of the fastening element 11, said second coupling part 22 being connected here directly to the fastening element 11, Moreover, the locking coupler 20—arranged between the first coupling part 21 and the second coupling part 22—is equipped with a coupler or coupling element 23.

As shown in detail in the embodiment of FIG. 1 and FIG. 2, a screw 14 allows a readjustment of the strap of the fastening element 11. Tightening the screw can intensify the non-positive fit of the strap with the neck of the device, for example, in the connection area 102. Thus, even if the tension of the strap diminishes, the add-on handle 10 remains securely fastened to the handheld power tool 100. Consequently, the screw 14 serves to pre-adjust the fastening element 11 in order to ultimately set the holding force that the fastening element 11 exerts on the neck of the device in the attached position A. The screw, however, does not have to be actuated during regular use in order to change the position of the fastening element 11 between an attaching position A and a detaching position L. Below, for the sake of simplicity, the positions of the locking coupler 20 associated with these positions A, L as well as the positions on the locking coupler 20 are likewise designated in this manner.

Here, the second coupling part 22 has approximately the shape of a disk whose bottom is affixed directly to the fastening element 11. For instance, the second coupling part 22 can be formed in one piece together with the fastening element 11. An engagement element 1 in the form of a journal that serves to create a bayonet catch—which will be elaborated upon below—on the locking coupler 20 is formed on the lateral exterior 22.1 of the disk. A cutout 24 is formed in the disk and it passes completely through the second coupling part 22 as well as through the fastening element 11. The top and the bottom of the disk have an opening that allows access to the connection area 102 on the neck of the housing 101.

A base 23.2 of the coupling element 23 engages with the cutout 24. More specifically, the coupling element 23 has the above-mentioned base 23.2 as well as an upper plate 23.1 that is shaped to approximately match the contour of the top of the disk. The bottom 23.3 of the base 23.2 has an especially soft elastomeric layer. This layer can make contact with the connection area 102 on the neck of the housing 101 without causing damage. The base 23.2 can be inserted into the cutout 24 in the disk-shaped second coupling part 22, whereby the height H of the base 23.2 is such that the base passes completely through the cutout 24 and its bottom 23.3 rests against the connection area 102 of the neck of the device. Here, the bottom 23.4 of the plate 23.1 surrounding the base 23.2 rests practically on the top of the disk on the second coupling part 22. The entire coupling element 23 is made of a relatively elastic material such as, for example, an elastomer, that is capable of transmitting compressive forces and of building up a compressive stress to offset this, in other words, it has a spring effect. The outer rim 23.5 of the plate 23.1 approximately matches the sleeve-like contour of the first coupling part 21 and fits into the frame 21.1 of the sleeve.

In the assembled state of the locking coupler 20, the first coupling part 21 can be pulled over the coupling element 23 that is located in the cutout 24 as well as over the second coupling part 22. The first and second coupling parts 21, 22 engage axially with each other along the axis 120 of the locking coupler, forming the bayonet catch. In this process, the engager or engagement element 1 configured as a journal engages with a guide 2 on the frame 21.1 of the sleeve of the first coupling part 21. Therefore, the guide 2 forms a slotted link having a suitable path that force-guides the engagement element 1 when the grip 12 is turned in the rotational direction D. In this manner, a bayonet catch is formed on the locking coupler 20 between the first coupling part 21 and the second coupling part 22 in that the engagement element 1 on the disk engages with the guide 2 on the pot.

In a particularly advantageous way, the bayonet catch here is pre-tensioned in any case due to the above-mentioned spring effect of the plate 23.1 of the coupling element 23. Therefore, owing to the spring tension of the coupling element 23, the bayonet catch is thus affixed at practically each rotational position of the grip 12, that is to say, at practically each angular value of the rotation D.

In the direction of the rotational position A, the engagement element 1 is force-guided to a top point A of the guide 2 when the grip 12 executes the rotation D. As a result, the disk of the second coupling part 22 is pulled into the first coupling part 21 configured as a counterpart of the disk, and the bayonet catch is closed. Moreover, the tension of the strap on the fastening element 11 is increased—in other words, a non-positive connection of the fastening element 11 on the neck of the device is established in the connection area 102. The grip 12 assumes the position A shown in FIG. 1. This corresponds to an attached position A of the fastening element 11 on the neck of the device. This attaching position A is appropriately indicated for the rotation D shown in FIG. 2.

In another direction of the rotation D, the engagement element 1 approaches a bottom L of the guide 2, which corresponds to the detaching position L of the rotational direction D. The disk of the second coupling part 22 is pushed out of the sleeve as a counterpart of the disk of the first coupling part 21, thus providing more space for the strap of the fastening element 11. This releases the non-positive connection on the neck of the device. This corresponds to the detaching position L of the fastening element 11. The grip 21 assumes the position L shown in FIG. 1. Since there is now more space between the first coupling part 21 and the second coupling part 22, on the one hand, the spring force of the plate 23.1 of the coupling element 23 diminishes. On the other hand, the bottom 23.3 of the base 23.2 no longer exerts pressure onto the neck of the device. The add-on handle 10 can thus be freely slid back and forth on the neck of the device or else rotated around the working axis 110. This setting can be selected by the user as needed in order to allow an ergonomic holding position of the handheld power tool 110 with the add-on handle 10 and, for this purpose, to change the center of gravity of the handheld power tool 100 relative to the user whenever necessary.

Conversely, in the above-mentioned attaching position A—due to the pressure exerted by the first coupling part 21 onto the plate 23.1—the base 23.2 is pushed through the cutout 24 onto the connection area on the neck of the device. On the one hand, this increases the non-positive connection on the neck of the device. On the other hand, the strap of the fastening element 11 is additionally pushed away from the neck of the device, in other words, it is additionally tensioned. With its effect, the coupling element 23 supports the change in the position of the fastening element 11 between the attaching position A and the detaching position L, namely, by positioning the base 23.2 on the connection area or by lifting the base 23.2 off the connection area. Aside from the effect of the clamping means brought about by the base 23.2, the coupling element 23 also has the above-mentioned effect of a spring means that is brought about by the plate 23.1 between the first coupling part 21 and the second coupling part 22. In this manner, an add-on handle 10 can be detached, adjusted and re-attached without actuating an additional operating element. Therefore, according to the concept of the invention, the effort needed to change the position of the add-on handle 10 is considerably reduced. Additional components for the implementation of the additional actuation element on the add-on handle can be dispensed with here.

In the especially preferred embodiment of the add-on handle 10 shown here, the guide 2 has a path that can be seen in FIG. 2 as an essentially ascending area. In the attaching position A, the path can have a receding area for purposes of affixing the engagement element 1 in the receding area. In order to move to the ascending area from the receding area, the engagement element 1 would have to overcome an upper point of the path—this translates into the desired securing of the bayonet catch in the attaching position A.

What is claimed is:

1. An add-on handle configured to be connected to a handheld power tool in a connection area of the tool, comprising:
a fastener configured to be attached to the connection area;
a hoop-shaped grip provided for handling purposes; and
a locking coupler connecting the grip and the fastener, and having an axis,
the grip rotatable around the axis to permit the locking coupler to be moved between an attaching position attaching the fastener and a second position detaching the fastener,
the locking coupler having a first coupling part actuatable via the grip and a second coupling part configured to change a position of the fastening element, the first and second coupling parts engaging axially with each other along the axis and forming a bayonet catch of the locking coupler between the coupling parts, the bayonet catch being configured with an engagement element movable so as to engage with a guide in such a way that, when the engagement element is moved between a first point of the guide and a second point of the guide, the fastener is moved between the attaching position and the detaching position.

2. The add-on handle as recited in claim 1 wherein the axis is oriented radially with respect to the connection area of the handheld power tool, or is oriented in a similar direction as a leg of the hoop-shaped grip.

3. The add-on handle as recited in claim 2 wherein the axis is oriented radially to a device neck of the handheld power tool.

4. The add-on handle as recited in claim 1 wherein the first coupling part is fastened directly to the hoop-shaped grip or the second coupling part is fastened directly to the fastening element.

5. The add-on handle as recited in claim 4 wherein the first and second coupling parts are formed in each case individually or wherein the first coupling part is formed in one piece with the hoop-shaped grip.

6. The add-on handle as recited in claim 1 wherein the second coupling part is configured in the form of a shaft, while the first coupling part is configured in the form of a sleeve, whereby the shaft engages with the sleeve axially.

7. The add-on handle as recited in claim 6 wherein the shaft is in the form of a disk, and the sleeve is in the form of a pot.

8. The add-on handle as recited in claim 6 wherein the shaft engages the sleeve with a precise fit.

9. The add-on handle as recited in claim 1 wherein a spring is arranged between the first coupling part and the second coupling part.

10. The add-on handle as recited in claim 9 wherein the spring is an elastomer part.

11. The add-on handle as recited in claim 9 wherein the spring is pre-tensioned.

12. The add-on handle as recited in claim 1 wherein the locking coupler has a tensioner passing through the second coupling part and configured such that, when the engagement element is moved between a first point of the guide and a second point of the guide, the tensioner assists the changing of the fastener between the attaching position and the detaching position.

13. The add-on handle as recited in claim 12 wherein the tensioner acts directly or indirectly upon the connection area of the handheld power tool.

14. The add-on handle as recited in claim 1 wherein the guide has a receding area associated with the attaching position.

15. The add-on handle as recited in claim 1 wherein the fastener is configured to create a non-positive connection with the connection area.

16. The add-on handle as recited in claim 1 wherein the fastener is configured to create a positive connection with the connection area.

17. The add-on handle as recited in claim 1 wherein the hoop-shaped grip is configured in the form of an open or closed hoop that is curved with an almost complete round angle.

18. A handheld power tool comprising:
a main handle;
a neck having a connection area; and
the add-on handle as recited in claim 1, the add-on handle configured as a side handle oriented perpendicular to the main handle.

19. The handheld power tool as recited in claim 18 wherein the tool is a hammer drill or a drill chisel.

20. The handheld power device as recited in claim 19 wherein the tool is a chisel hammer.

21. A system comprising:
the handheld power tool; and
the add-on handle as recited in claim 1.
